(19) United States
(12) Patent Application Publication
(10) Pub. No.: US 2021/0142303 A1
(43) Pub. Date: May 13, 2021

(54) METHODS AND SYSTEMS FOR FUND TRANSFERS

(71) Applicant: Visa International Service Association, San Francisco, CA (US)

(72) Inventors: Brian David Moose, Paso Robles, CA (US); Todd Joseph Rosenthal, Menlo Park, CA (US)

(21) Appl. No.: 17/097,145

(22) Filed: Nov. 13, 2020

Related U.S. Application Data
(60) Provisional application No. 62/934,756, filed on Nov. 13, 2019.

(51) Int. Cl. G06Q 20/10; G06Q 20/32

(52) U.S. Cl. CPC G06Q 20/108; G06Q 20/326; G06Q 20/3276

(57) ABSTRACT

A computer-implemented method for fund disbursement and notification includes: receiving a fund transfer request including at least one of the following: at least one fund provider, at least one fund receiver, a fund amount, or any combination thereof; in response to determining at least one fund benefactor associated with the at least one fund receiver, transferring to or initiating the transfer of at least a portion of the fund amount to the at least one fund benefactor; and generating and transmitting a transfer notification to at least one of the following: the at least one fund provider, the at least one fund receiver, the at least one fund benefactor, or any combination thereof.

### CROSS REFERENCE TO RELATED APPLICATION

This application claims priority to U.S. Provisional Patent Application No. 62/934,756, filed Nov. 13, 2019, the disclosure of which is incorporated herein by reference in its entirety.

### BACKGROUND

### 1. Technical Field

The present disclosure relates generally to methods and systems for facilitating monetary transfers between fund providers and fund receivers, and in some non-limiting embodiments or aspects, to facilitating monetary (or fund) transfers in the form of tips, gratuities, and the like between parties.

### 2. Technical Considerations

Providing gratuities or “tipping” is a common practice between a service receiver and a service provider, e.g., housekeepers, wait staff, valet, service staff, and the like. Oftentimes, the tipper (or fund provider) does not have the appropriate amount or denomination to provide the gratuity, or may not be in a position to provide monies in the correct form. Further, the service provider (or fund receiver) may wish to provide another person with the benefit of the tip or gratuity, as a benefactor.

Therefore, there is a need in the art to enable fund providers to transfer funds, e.g., gratuities, tips, and the like, to fund receivers in electronic form. There is further need in the art to enable fund receivers to assign or designate fund benefactors that can automatically receive some or all of the fund amount.

### SUMMARY

Accordingly, provided are improved methods and systems for facilitating fund transfers between fund providers and fund receivers.

According to some non-limiting embodiments or aspects, provided is a computer-implemented method for fund disbursement and notification comprising: receiving, with at least one processor, a fund transfer request including at least one of the following: at least one fund provider, at least one fund receiver, a fund amount, or any combination thereof; in response to determining at least one fund benefactor associated with the at least one fund receiver, transferring to or initiating the transfer of, with at least one processor, at least a portion of the fund amount to the at least one fund benefactor; and generating and transmitting, with at least one processor, a transfer notification to at least one of the following: the at least one fund provider, the at least one fund receiver, the at least one fund benefactor, or any combination thereof.

In some non-limiting embodiments or aspects, the fund transfer request may further include at least one service category associated with a plurality of fund receivers. The method may include: determining, with at least one processor, at least one fund receiver of the plurality of fund receivers in the at least one service category; and assigning, with at least one processor, at least a portion of the fund amount for transfer to the at least one fund receiver. In some non-limiting embodiments or aspects, a plurality of fund benefactors may be associated with the at least one fund receiver. In some non-limiting embodiments or aspects, the method may include: determining, with at least one processor, at least one fund benefactor of the plurality of fund benefactors; and assigning, with at least one processor, at least a portion of the fund amount for transfer to the at least one fund benefactor.

According to some non-limiting embodiments or aspects, provided is a system for conducting a person-to-person fund transfer between a fund provider and a fund receiver comprising: a fund provider device having at least one processor, the fund provider device programmed or configured to: determine or select a fund receiver and a fund amount; generate a fund transfer request including the fund receiver and the fund amount; and transmit the fund transfer request; and a fund receiver device having at least one processor, the fund receiver device programmed or configured to: communicate fund receiver data to the fund provider device, where a fund transfer process is initiated from the fund provider to the fund receiver based on the fund transfer request.

In some non-limiting embodiments or aspects, the at least one of the fund provider device and the fund receiver device may include at least one of the following: a computing device, a mobile device, an electronic device, a wearable device, a wireless communication device, or any combination thereof. In some non-limiting embodiments or aspects, the fund transfer process may be initiated in response to arranging the fund provider device proximate the fund receiver device. In some non-limiting embodiments or aspects, the fund receiver device may include a wearable device worn by the fund receiver. In some non-limiting embodiments or aspects, a transfer indication may be displayed on at least one of the fund provider device and the fund receiver device upon completion of the fund transfer process. In some non-limiting embodiments or aspects, the fund transfer process may further include automatically initiating a transfer of at least a portion of the fund amount to at least one fund benefactor. In some non-limiting embodiments or aspects, the initiation of the fund transfer may automatically occur upon receipt of the fund transfer request on the fund receiver device.

According to some non-limiting embodiments or aspects, provided is a computer-implemented method for conducting a person-to-person fund transfer between a fund provider and a fund receiver comprising: receiving, with at least one processor, a computer-readable code including data associated with at least one of the following: at least one fund provider, at least one fund receiver, a fund amount, or any combination thereof; reading, with at least one processor, the computer-readable code; in response to reading the computer-readable code, determining, with at least one processor, the at least one fund receiver and the fund amount; and initiating, with at least one processor, the transfer of at least a portion of the fund amount to the at least one fund receiver.

In some non-limiting embodiments or aspects, the computer-implemented method may further include: generating, with at least one processor, the computer-readable code; and associating, with at least one processor, the computer-readable code with at least one fund receiver. In some non-limiting embodiments or aspects, the computer-readable code may include a QR code. In some non-limiting embodiments or aspects, the computer-implemented method may further include: printing, with at least one printing device, the computer-readable code on a physical medium. In some non-limiting embodiments or aspects, the computer-readable code may include at least one service category associated with a plurality of fund receivers. In some non-limiting embodiments or aspects, the computer-implemented method may include: determining, with at least one processor, at least one fund receiver of the plurality of fund receivers in the at least one service category; and assigning, with at least one processor, at least a portion of the fund amount for transfer to the at least one fund receiver. In some non-limiting embodiments or aspects, the computer-implemented method may further include generating, with at least one processor, a fund transfer notification including at least one of the following: the at least one fund provider, the at least one fund receiver, the fund amount, a message, or any combination thereof. In some non-limiting embodiments or aspects, and in response to the at least one fund receiver receiving the at least a portion of the fund amount, a second transfer of at least a portion of the fund amount to at least one fund benefactor may automatically be initiated.

Further non-limiting embodiments or aspects are set forth in the following numbered clauses:

Clause 1: A computer-implemented method for fund disbursement and notification, comprising: receiving, with at least one processor, a fund transfer request comprising at least one of the following: at least one fund provider, at least one fund receiver, a fund amount, or any combination thereof; in response to determining at least one fund benefactor associated with the at least one fund receiver, transferring to or initiating the transfer of, with at least one processor, at least a portion of the fund amount to the at least one fund benefactor; and generating and transmitting, with at least one processor, a transfer notification to at least one of the following: the at least one fund provider, the at least one fund receiver, the at least one fund benefactor, or any combination thereof.

Clause 2: The computer-implemented method of clause 1, wherein the fund transfer request further comprises at least one service category associated with a plurality of fund receivers.

Clause 3: The computer-implemented method of clause 1 or 2, comprising: determining, with at least one processor, at least one fund receiver of the plurality of fund receivers in the at least one service category; and assigning, with at least one processor, at least a portion of the fund amount for transfer to the at least one fund receiver.

Clause 4: The computer-implemented method of any of clauses 1-3, wherein a plurality of fund benefactors are associated with the at least one fund receiver.

Clause 5: The computer-implemented method of any of clauses 1-4, comprising: determining, with at least one processor, at least one fund benefactor of the plurality of fund benefactors; and assigning, with at least one processor, at least a portion of the fund amount for transfer to the at least one fund benefactor.

Clause 6: A system for conducting a person-to-person fund transfer between a fund provider and a fund receiver, comprising: a fund provider device having at least one processor, the fund provider device programmed or configured to: determine or select a fund receiver and a fund amount; generate a fund transfer request comprising the fund receiver and the fund amount; and transmit the fund transfer request; and a fund receiver device having at least one processor, the fund receiver device programmed or configured to: communicate fund receiver data to the fund provider device, wherein a fund transfer process is initiated from the fund provider to the fund receiver based on the fund transfer request.

Clause 7: The system of clause 6, wherein at least one of the fund provider device and the fund receiver device comprises at least one of the following: a computing device, a mobile device, an electronic device, a wearable device, a wireless communication device, or any combination thereof.

Clause 8: The system of clause 6 or 7, wherein the fund transfer process is initiated in response to arranging the fund provider device proximate the fund receiver device.

Clause 9: The system of any of clauses 6-8, wherein the fund receiver device comprises a wearable device worn by the fund receiver.

Clause 10: The system of any of clauses 6-9, wherein a transfer indication is displayed on at least one of the fund provider device and the fund receiver device upon completion of the fund transfer process.

Clause 11: The system of any of clauses 6-10, wherein the fund transfer process further comprises automatically initiating a transfer of at least a portion of the fund amount to at least one fund benefactor.

Clause 12: The system of any of clauses 6-11, wherein the initiation of the fund transfer automatically occurs upon receipt of the fund transfer request on the fund receiver device.

Clause 13: A computer-implemented method for conducting a person-to-person fund transfer between a fund provider and a fund receiver, comprising: receiving, with at least one processor, a computer-readable code comprising data associated with at least one of the following: at least one fund provider, at least one fund receiver, a fund amount, or any combination thereof; reading, with at least one processor, the computer-readable code; in response to reading the computer-readable code, determining, with at least one processor, the at least one fund receiver and the fund amount; and initiating, with at least one processor, the transfer of at least a portion of the fund amount to the at least one fund receiver.

Clause 14: The computer-implemented method of clause 13, further comprising: generating, with at least one processor, the computer-readable code; and associating, with at least one processor, the computer-readable code with at least one fund receiver.

Clause 15: The computer-implemented method of clause 13 or 14, wherein the computer-readable code comprises a QR code.

Clause 16: The computer-implemented method of any of clauses 13-15, further comprising: printing, with at least one printing device, the computer-readable code on a physical medium.

Clause 17: The computer-implemented method of any of clauses 13-16, wherein the computer-readable code comprises at least one service category associated with a plurality of fund receivers.

Clause 18: The computer-implemented method of any of clauses 13-17, comprising: determining, with at least one processor, at least one fund receiver of the plurality of fund receivers in the at least one service category; and assigning, with at least one processor, at least a portion of the fund amount for transfer to the at least one fund receiver.

Clause 19: The computer-implemented method of any of clauses 13-18, further comprising generating, with at least one processor, a fund transfer notification comprising at least one of the following: the at least one fund provider, the at least one fund receiver, the fund amount, a message, or any combination thereof.

Clause 20: The computer-implemented method of any of clauses 13-19, wherein in response to the at least one fund receiver receiving the at least a portion of the fund amount, a second transfer of at least a portion of the fund amount to at least one fund benefactor is automatically initiated.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a system for conducting a fund transfer according to some non-limiting embodiments or aspects;

FIG. 2 is a diagram of a system for conducting a fund transfer according to some non-limiting embodiments or aspects;

FIGS. 3A-3C show computing devices displaying a notification message according to some non-limiting embodiments or aspects;

FIGS. 4A-4D show computing devices displaying user interfaces generated for conducting a fund transfer according to some non-limiting embodiments or aspects;

FIGS. 5A-5C show illustrations of steps performed for conducting a fund transfer according to some non-limiting embodiments or aspects;

FIGS. 6A-6D show illustrations of steps performed for conducting a fund transfer according to some non-limiting embodiments or aspects;

FIG. 7 is a diagram of components of one or more devices from FIGS. 1-6D according to some non-limiting embodiments or aspects;

FIG. 8 is a step diagram of a computer-implemented method for fund disbursement and notification according to some non-limiting embodiments or aspects; and

FIG. 9 is a step diagram of a computer-implemented method for conducting a person-to-person fund transfer between a fund provider and a fund receiver.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components are described to illustrate the wide variety of possible embodiments of the disclosure.

As used herein, the term “account identifier” may include one or more types of identifiers associated with a user account (e.g., a primary account number (PAN), a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution, such that an account identifier may be a token that maps to a PAN or other type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer” may refer to an entity licensed by the transaction service provider and approved by the transaction service provider to originate transactions (e.g., payment transactions) using a payment device associated with the transaction service provider. As used herein, the term “acquirer system” may also refer to one or more computer systems, computer devices, and/or the like operated by or on behalf of an acquirer. The transactions the acquirer may include are payment transactions (e.g., purchases, original credit transactions (OCTs), account funding transactions (AFTs), and/or the like). In some non-limiting embodiments or aspects, the acquirer may be authorized by the transaction service provider to assign merchants or service providers to originate transactions using a payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure that proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitators, and/or the like. In some non-limiting embodiments or aspects, an acquirer may be a financial institution, such as a bank.

As used herein, the terms “client,” “client device,” “fund provider device,” “fund receiver device,” and “fund benefactor device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), personal digital assistants (PDAs), and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. The computing device may be a non-mobile device, such as a desktop computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “issuer institution” may refer to one or more entities, such as a bank, that provide accounts to users for conducting transactions (e.g., payment transactions), such as initiating credit and/or debit payments. For example, an issuer institution may provide an account identifier, such as a PAN, to a user that uniquely identifies one or more accounts associated with that user. The account identifier may be embodied on a payment device, such as a physical financial instrument, e.g., a payment card, and/or may be electronic and used for electronic payments. The term “issuer system” refers to one or more computer systems, computing devices, software applications, and/or the like, operated by or on behalf of an issuer institution, such as a server computer executing one or more software applications. For example, an issuer system may include one or more authorization servers for authorizing a transaction, one or more authentication servers for authenticating a transaction, and/or one or more databases of account data. An issuer system may include a separate or integrated issuer authentication system, such as an Access Control Server (ACS), for authenticating online transactions. An issuer institution may be associated with the BIN or other unique identifier that uniquely identifies it among other issuer institutions.

As used herein, the term “merchant” may refer to an individual or entity that provides goods and/or services, or access to goods and/or services, to users (e.g., consumers) based on a transaction (e.g., an electronic payment transaction). The term “merchant system” may refer to one or more computer systems, computing devices, and/or software applications operated by or on behalf of a merchant, such as a server computer executing one or more software applications. As used herein, the term “point-of-sale (POS) system” may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, PDA, a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like operated by or on behalf of a payment gateway and/or to a payment gateway itself. The term “payment gateway mobile application” may refer to one or more electronic devices and/or one or more software applications configured to provide payment services for transactions (e.g., payment transactions, electronic payment transactions, and/or the like).

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting embodiments or aspects, a payment token may be “format preserving” and may have a numeric format that conforms to the account identifiers used in existing payment processing networks (e.g., ISO 8583 financial transaction message format). In some non-limiting embodiments or aspects, a payment token may be used in place of a PAN to initiate, authorize, settle, or resolve a payment transaction or represent the original credential in other systems where the original credential would typically be provided. In some non-limiting embodiments or aspects, a token value may be generated such that the recovery of the original PAN or other account identifier from the token value may not be computationally derived (e.g., with a one-way hash or other cryptographic function). Further, in some non-limiting embodiments or aspects, the token format may be configured to allow the entity receiving the payment token to identify it as a payment token and recognize the entity that issued the token.

As used herein, the term “point-of-sale (POS) device” may refer to one or more devices, which may be used by a merchant to initiate transactions (e.g., a payment transaction), engage in transactions, and/or process transactions. For example, a POS device may include one or more computers, peripheral devices, card readers, NFC receivers, RFID receivers, and/or other contactless transceivers or receivers, contact-based receivers, payment terminals, computers, servers, input devices, and/or the like.

As used herein, the term “provisioning” may refer to a process of enabling a device to use a resource or service. For example, provisioning may involve enabling a device to perform transactions using an account. Additionally or alternatively, provisioning may include adding provisioning data associated with account data (e.g., a payment token representing an account number) to a device.

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as VISA® or any other entity that processes transactions. As used herein, the term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments or aspects of the present disclosure are directed to methods, systems, and computer program products for fund disbursement and notification and/or conducting person-to-person fund transfers between fund providers and fund receivers. Non-limiting embodiments or aspects enable receivers of fund transfers (e.g., tip/gratuity fund transfers) to automatically redirect at least a portion of the fund amount of the fund transfer to a fund benefactor. As such, the transfer to the fund benefactor may be conducted more efficiently by removing any active step required by the fund receiver at the time of the fund transfer from the fund provider to the fund receiver to transfer the funds to the fund benefactor. Moreover, the fund receiver is provided with increased flexibility in managing the funds transferred or intended to be transferred to the fund receiver's account.

Non-limiting embodiments or aspects enable person-to-person fund transfers to be conducted by the fund provider initiating the fund transfer to the fund receiver by positioning the fund provider device proximate the fund receiver device. In this proximate arrangement, the fund receiver device may communicate data (e.g., fund receiver data) required by the fund provider device to generate a fund transfer request. Thus, by positioning the fund provider device and fund receiver device proximate one another, the fund provider device may initiate fund transfer to the desired fund receiver, which enhances the efficiency by which the person-to-person fund transfers are conducted.

Non-limiting embodiments or aspects utilize a computer-readable code readable by the fund provider device, to enable the fund provider device to generate the fund transfer request to initiate the fund transfer process. The computer-readable code may contain fund receiver data, and each fund receiver may have an associated computer-readable code unique to the fund receiver or a service category or other grouping associated with the fund receiver. As such, the use of the computer-readable code enhances the efficiency by which the person-to-person fund transfers are conducted.

Accordingly, the present disclosure provides additional efficiency to the fund disbursement and notification process when conducting person-to-person fund transfers.

The fund transfers herein may comprise any type of person-to-person fund transfer. In some non-limiting embodiments or aspects, the methods, systems, and computer program products may be particularly useful in person-to-person transfers associated with tips/gratuity, where the fund provider may be a customer/service receiver and the fund receiver may be a service provider. Non-limiting examples of service providers who may receive tips through the methods, systems, and computer program products described herein include: restaurant service individuals, transportation service individuals, beauty service individuals, delivery service individuals, hotel service individuals, entertainment service individuals, and the like.

Referring now to FIG. 1, FIG. 1 is a diagram of a non-limiting embodiment of an environment 100 in which systems, products, and/or methods, as described herein, may be implemented. As shown in FIG. 1, the environment 100 may include transaction service provider system 102, issuer system 104, fund provider device 106, fund receiver device 107, merchant system 108, fund benefactor device 109, acquirer system 110, and/or network 112.

The transaction service provider system 102 may include one or more devices capable of receiving information from and/or communicating information to the issuer system 104, the fund provider device 106, the fund receiver device 107, the merchant system 108, the fund benefactor device 109, and/or the acquirer system 110 via the network 112. For example, the transaction service provider system 102 may include a computing device, such as a server (e.g., a transaction processing server), a group of servers, and/or other like devices. In some non-limiting embodiments or aspects, the transaction service provider system 102 may be associated with a transaction service provider as described herein. In some non-limiting embodiments or aspects, the transaction service provider system 102 may be in communication with a data storage device, which may be local or remote to the transaction service provider system 102. In some non-limiting embodiments or aspects, the transaction service provider system 102 may be capable of receiving information from, storing information in, communicating information to, or searching information stored in the data storage device.

The issuer system 104 may include one or more devices capable of receiving information and/or communicating information to the transaction service provider system 102, the fund provider device 106, the fund receiver device 107, the merchant system 108, the fund benefactor device 109, and/or the acquirer system 110 via the network 112. For example, the issuer system 104 may include a computing device, such as a server, a group of servers, and/or other like devices. In some non-limiting embodiments or aspects, the issuer system 104 may be associated with an issuer institution as described herein. For example, the issuer system 104 may be associated with an issuer institution that issued a credit account, debit account, credit card, debit card, and/or the like to a user associated with the fund provider device 106.

The fund provider device 106, fund receiver device 107, and/or fund benefactor device 109 may include one or more devices capable of receiving information from and/or communicating information to the transaction service provider system 102, the issuer system 104, the merchant system 108, and/or the acquirer system 110 via the network 112. Additionally or alternatively, some or all of the fund provider device 106, fund receiver device 107, and fund benefactor device 109 may include a device capable of receiving information from and/or communicating information to other fund provider devices 106, fund receiver devices 107, and/or fund benefactor devices 109 via the network 112, another network (e.g., an ad hoc network, a local network, a private network, a virtual private network, and/or the like), and/or any other suitable communication technique. For example, the fund provider device 106, fund receiver device 107, and/or fund benefactor device 109 may include a client device and/or the like. In some non-limiting embodiments or aspects, fund provider device 106, fund receiver device 107, and/or fund benefactor device 109 may be capable of receiving information (e.g., from another device (e.g., the fund provider device 106, fund receiver device 107, fund benefactor device 109, and the like)) via a short-range wireless communication connection (e.g., an NFC communication connection, an RFID communication connection, a Bluetooth® communication connection, a Zigbee® communication connection, and/or the like), and/or communicating (or transmitting) information (e.g., to the fund provider device 106, fund receiver device 107, fund benefactor device 109, and the like) via a short-range wireless communication connection. The fund provider device 106, the fund receiver device 107, and/or the fund benefactor device 109 may comprise at least one of the following: a computing device, a mobile device, an electronic device, a wearable device, a wireless communication device, or any combination thereof.

The merchant system 108 may include one or more devices capable of receiving information from and/or communicating information to the transaction service provider system 102, the issuer system 104, the fund provider device 106, the fund receiver device 107, the fund benefactor device 109, and/or the acquirer system 110 via the network 112. The merchant system 108 may also include a device capable of receiving information from the fund provider device 106, fund receiver device 107, and/or fund benefactor device 109, via the network 112, by a communication connection (e.g., an NFC communication connection, an RFID communication connection, a Bluetooth® communication connection, a Zigbee® communication connection, and/or the like) with the fund provider device 106, fund receiver device 107, fund benefactor device 109, and/or the like, and/or communicating information to the fund provider device 106, fund receiver device 107, and/or fund benefactor device 109, via the network 112, by the communication connection, and/or the like. In some non-limiting embodiments or aspects, the merchant system 108 may include a computing device, such as a server, a group of servers, a client device, a group of client devices, and/or other like devices. In some non-limiting embodiments or aspects, the merchant system 108 may be associated with a merchant as described herein. In some non-limiting embodiments or aspects, the merchant system 108 may include one or more client devices. For example, the merchant system 108 may include a client device that allows a merchant to communicate information to the transaction service provider system 102. In some non-limiting embodiments or aspects, the merchant system 108 may include one or more devices, such as computers, computer systems, and/or peripheral devices capable of being used by a merchant to conduct a transaction with a user. For example, the merchant system 108 may include a POS device and/or a POS system. It will be appreciated that the merchant system may be operated by or on behalf of a merchant employing the individuals to whom the fund amount is transferred (the fund receivers).

The acquirer system 110 may include one or more devices capable of receiving information from and/or communicating information to the transaction service provider system 102, the issuer system 104, the fund provider device 106, the fund receiver device 107, the merchant system 108, and/or the fund benefactor device 109, via the network 112. For example, the acquirer system 110 may include a computing device, a server, a group of servers, and/or the like. In some non-limiting embodiments or aspects, the acquirer system 110 may be associated with an acquirer as described herein.

The network 112 may include one or more wired and/or wireless networks. For example, the network 112 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the internet, a fiber optic-based network, a cloud computing network, and/or the like, and/or a combination of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple distributed systems or devices. Additionally or alternatively, a set of systems (e.g., one or more systems) or a set of devices (e.g., one or more devices) of environment 100 may perform one or more functions described as being performed by another set of systems or another set of devices of environment 100.

With continued reference to FIG. 1, in some non-limiting embodiments or aspects, the environment 100 may execute a computer implemented method and system for fund disbursement and notification. At least one processor (hereinafter the “Processor”), such as at least one processor of the transaction service provider system 102, issuer system 104, merchant system 108, and/or acquirer system 110 may receive a fund transfer request. The fund transfer request may initiate a person-to-person fund transfer, such as a fund transfer associated with a tip/gratuity. The fund transfer request may be received from the fund provider device 106. The fund transfer request may comprise a fund provider (e.g., the identity of the fund provider and/or contact data, device data, and/or account data associated with the fund provider). The fund transfer request may comprise at least one fund receiver (e.g., the identity of the fund receiver, contact data and/or device (fund receiver device 107) data associated with the fund receiver, account data associated with the fund receiver). The fund transfer request may comprise at least one fund amount associated with the fund transfer. Any combination of this data may be comprised in the fund transfer request. The fund transfer request may comprise a description of the reason the fund amount is being transferred or a message associated with the fund transfer. The fund transfer request may comprise at least one service category associated with the fund receiver(s).

In some non-limiting embodiments or aspects, in response to receiving the fund transfer request, the Processor may determine at least one fund benefactor associated with the at least one fund receiver. In some non-limiting embodiments or aspects, fund benefactors associated with fund receivers may be stored in a database (not shown) which associates a fund receiver with at least one fund benefactor. The fund receiver device 107 may communicate with the database to update the fund benefactor(s) associated with the fund receiver.

In some non-limiting embodiments or aspects, the Processor may communicate with the fund receiver device 107 to cause the fund receiver device 107 to provide at least one fund benefactor to whom the funds are to be transferred and/or to select at least one fund benefactor from the list of stored associated fund benefactors to whom the funds are to be transferred.

The Processor may determine a single fund benefactor in response to receiving the fund transfer request, or the Processor may determine a plurality of fund benefactors in response to receiving the fund transfer request, and the portion of the funds may be automatically transferred to the single or plurality of fund benefactors.

In some non-limiting embodiments or aspects, a plurality of fund benefactors may be associated with the fund receiver. The Processor may determine at least one fund benefactor of the plurality of fund benefactors to receive at least a portion of the fund amount, such as a single fund benefactor from the plurality of fund benefactors or a subset of fund benefactors from the plurality of fund benefactors. Based on this determination, the Processor may assign the portion of the fund amount for transfer to the at least one determined fund benefactor and transfer or initiate transfer to the determined fund benefactor(s).

In some non-limiting embodiments or aspects, determining the fund benefactor may include determining the identity of the fund benefactor, contact data and/or device (fund benefactor device 109) data associated with the fund benefactor, account data associated with the fund benefactor, and the like.

In response to determining the fund benefactor(s) associated with the fund receiver, the Processor may transfer to or initiate the transfer of at least a portion of the fund amount to the at least one fund benefactor, in some non-limiting embodiments or aspects. The entire fund amount may be transferred to the fund benefactor. Alternatively, a specified amount and/or percentage of the fund amount may be transferred to the fund benefactor. In some non-limiting examples, the fund receiver may receive and retain at least a portion of the fund amount while the remainder is transferred to the fund benefactor(s). In some non-limiting embodiments or aspects, the entire fund amount may be transferred to a single fund benefactor or split between multiple fund benefactors. The fund receiver (e.g., via the fund receiver device 107) may specify the apportionment of the fund amount, either at the time of the reception of the fund transfer request or prior to receiving the fund transfer request.

Referring to FIG. 2, the method and system 200 for conducting a fund transfer may include a fund provider account 202, a fund receiver account 204, and a fund benefactor account 206, in some non-limiting embodiments or aspects. The fund provider account 202, fund receiver account 204, and fund benefactor account 206 may be a financial account containing funds of the fund provider, fund receiver, and fund benefactor, respectively. The fund provider account 202 may be an account associated with the fund provider and issued to the fund provider by an issuer institution. The fund receiver account 204 may be an account associated with the fund receiver and issued to the fund receiver by an issuer institution. The fund provider benefactor 206 may be an account associated with the fund benefactor and issued to the fund benefactor by an issuer institution. The issuer institutions of the fund provider account 202, the fund receiver account 204, and the fund benefactor account 206 may be the same or different.

With continued reference to FIG. 2, based on the fund transfer request and the determined fund receiver and fund benefactor, at least a portion of the fund amount may be transferred from the fund provider account 202 to the fund receiver account 204 and/or the fund benefactor account 206. In some non-limiting embodiments or aspects, at least a portion of the fund amount may first be transferred to the fund receiver account 204, and subsequently at least a portion thereof may be automatically transferred to the fund benefactor account 206, e.g., without intervention of the fund receiver initiating a separate transfer request. It will be appreciated that the fund receiver device may be prompted by the Processor to respond to select a fund benefactor, but the further transfer from the fund receiver account 204 to the fund benefactor account 206 may automatically be effected without a fund transfer request being generated by the fund receiver device.

In some non-limiting embodiments or aspects, at least a portion of the fund amount may be transferred directly to the fund benefactor account 206, without the portion of the funds first being transferred to the fund receiver account 204. In some non-limiting embodiments or aspects, a first portion of the fund amount may be transferred directly to the fund benefactor account 206 simultaneously with a second portion being transferred directly to the fund receiver account 204.

Referring again to FIG. 1 and referring also to FIGS. 3A-3C, in some non-limiting embodiments or aspects, the Processor may generate and transmit a transfer notification message to at least one of the fund provider device 106, fund receiver device 107, and/or fund benefactor device 109. The transfer notification may be generated and transmitted to the fund provider device 106, fund receiver device 107, and/or fund benefactor device 109 simultaneously with transfer of the fund amount and/or shortly after completion of the fund transfer, such as within 1 hour, 30 minutes, 15 minutes, 5 minutes, or 1 minute of completion of the fund transfer.

In some non-limiting embodiments, as shown in FIG. 3A, the transfer notification may be generated by the Processor and transmitted to the fund benefactor device 109. The transfer notification may identify the portion of the fund amount transferred to the fund benefactor. The transfer notification may identify the fund receiver who directed the portion of the fund amount be transferred to the fund benefactor. The transfer notification may identify the fund provider who directed the fund amount be transferred to the fund receiver.

In some non-limiting embodiments, as shown in FIG. 3B, the transfer notification may be generated by the Processor and transmitted to the fund receiver device 107. The transfer notification may identify the fund amount (or portion thereof) transferred to the fund receiver and/or the fund benefactor. The transfer notification may identify the fund benefactor to whom the portion of the funds were transferred. The transfer notification may identify the fund provider who directed the fund amount be transferred to the fund receiver.

In some non-limiting embodiments, as shown in FIG. 3C, the transfer notification may be generated by the Processor and transmitted to the fund provider device 106. The transfer notification may identify the fund amount transferred to the fund receiver and/or fund benefactor. The transfer notification may identify the fund receiver to whom the fund provider directed the fund amount be transferred. The transfer notification may identify the fund benefactor to whom the fund receiver directed the fund amount be transferred.

Referring to FIGS. 4A-4C, computing devices displaying user interfaces generated for conducting a fund transfer are shown according to some non-limiting embodiments or aspects. FIG. 4A shows a fund provider device 106 in which the fund provider is prompted by the user interface displayed thereon to specify a fund amount to be transferred. The fund amount may be a tip and/or gratuity. The fund provider may select a fund amount on the fund provider device 106, such as by selecting a suggested fund amount on the user interface. The fund provider may select a fund amount on the fund provider device 106 by entering a fund amount on the user interface. The fund amount may be selected by the fund provider as a specific fund amount and/or as a percentage based on a transaction amount of an associated payment transaction (e.g., 15% of a restaurant bill as a tip). The fund amount may be transferred from an account associated with the fund provider, and the fund account may be a financial account associated with the fund provider, such as a bank account issued to the fund provider by an issuer institution and/or a rewards account issued to the fund provider by an issuer institutions, merchant, loyalty program, and/or the like.

In some non-limiting embodiments or aspects and referring to FIGS. 4B-4C, the fund provider device 106 may identify the fund receiver to whom the fund amount is to be transferred. The fund provider may enter an identifier associated with the fund receiver into the fund transfer device 106 to identify the fund receiver. The identifier may include a name of the fund receiver, or other unique identifier associated with the fund receiver. The fund provider may select the fund receiver from a pre-populated list of potential fund receivers displayed on the fund provider device 106. The pre-populated list may be generated by the Processor and communicated to the fund provider device 106.

In some non-limiting embodiments, to identify the fund receiver(s), the user interface of the fund provider device 106 may display a plurality of service categories associated with a merchant associated with the fund transfer (e.g., the merchant employing potential fund receivers), to narrow the list of potential fund receivers. For example, in the case of a hotel merchant, the fund provider may identify the service category among a predetermined list of hotel service categories (e.g., valet, bellhop, front desk, housekeeping, and the like) in order to narrow this list of potential fund receivers associated with the service categories (see FIG. 4B). In response to the fund provider selecting the service category in FIG. 4B, the fund transfer device 106 may display a user interface listing the individuals of the merchant associated with the selected service category. The fund provider may select the fund receiver(s) from this list (see FIG. 4C). This selection may be communicated to the Processor, such that the Processor may determine the fund receiver from a plurality of potential fund receivers in the service categories. The Processor may assign the fund amount (or a portion thereof) be transferred to the determined fund receiver(s).

Referring to FIG. 4D, in some non-limiting embodiments or aspects, the fund amount may be transferred to the fund receiver and/or the fund receiver's benefactor based on this input from the fund provider identifying the fund receiver. The fund receiver device 107 may receive a transfer notification in response to receiving the fund amount from the fund provider.

Referring again to FIG. 1 and referring to FIGS. 5A-5C, systems and methods for conducting person-to-person fund transfers between fund providers and fund receivers are shown according to some non-limiting embodiments or aspects. The system may include a fund provider device 106 and a fund receiver device 107. Referring to FIG. 5A, the fund provider may select a fund amount on the fund provider device 106, as described in connection with FIG. 4A, such that the fund provider device determines a fund amount.

With continued reference to FIGS. 1 and 5A-5C, the fund provider device 106 may also determine a fund receiver. The fund receiver may be determined as described above, such as in connection with FIGS. 4B-4C. Referring to FIG. 5B, in some non-limiting embodiments or aspects, the fund provider device 106 may determine the fund receiver based on communicating with the fund receiver device 107. The fund transfer process of transferring the fund amount from the fund provider to the fund receiver (and/or the fund benefactor) may be initiated in response to arranging the fund provider device 106 proximate the fund receiver device 107, such that the fund provider device 106 and the fund receiver device 107 may communicate with one another, and such communication may enable the fund provider device 106 to determine the fund receiver (e.g., by the fund receiver device 107 communicating a fund receiver identifier or other such data to the fund provider device 106).

With continued reference to FIG. 5B, the fund provider device 106 (e.g., a smartphone of the fund provider), may be arranged proximate the fund receiver device 107, a non-limiting example of which is a wearable device worn by the fund receiver. Thus, arranging the fund provider device 106 proximate the wearable fund receiver device 107 may initiate the fund transfer process and may enable the fund provider device 106 to determine the fund receiver. The fund receiver device 107 may be configured to receive the fund transfer request from the fund provider device 106. The fund receiver device 107 may be configured to communicate fund receiver data to the fund receiver device 106 to enable the fund receiver device to generate the fund transfer request, which may identify the fund receiver.

The fund provider device 106 may generate a fund transfer request comprising the determined fund receiver and fund amount and may communicate the fund transfer request to the Processor as previously described in connection with FIG. 1. The fund transfer process may be initiated based on the fund transfer request being received by the Processor from the fund provider device 106, and the fund amount (or portion thereof) may be transferred from the fund provider to the fund receiver (and/or fund benefactor). In some non-limiting embodiments or aspects, the fund transfer process may automatically initiate a transfer of at least a portion of the fund amount to a fund benefactor, as previously described in connection with FIG. 1.

In some non-limiting embodiments or aspects, the fund provider device 106 may generate the fund transfer request and may communicate the fund transfer request to the fund receiver device 107. The fund receiver device 107 may accept or decline the fund transfer request to determine whether the fund transfer process should be initiated. In response to the fund receiver device 107 declining the fund transfer request, the fund transfer process may not be initiated and/or may be terminated. In response to the fund receiver device 107 accepting the fund transfer request, the fund transfer process may be initiated or continued by the fund provider device 106 and/or the fund receiver device 107 communicating the fund transfer request to the Processor.

In some non-limiting embodiments or aspects, the fund transfer process may be automatically initiated upon receipt of the fund transfer request by the fund receiver device 107. The fund provider device 106 may communicate the fund transfer request to the fund receiver device 107 as a notification of an initiated fund transfer and may communicate the fund transfer request to the Processor to automatically initiate the fund transfer process (without the fund receiver device 107 first approving or declining the fund transfer).

As shown in FIG. 5C, a transfer indication may be displayed on the fund provider device 106 and/or the fund receiver device 107 upon completion of the fund transfer process, in some non-limiting embodiments or aspects. The transfer indication may be a visual indicator, audible indicator, and/or tactile indicator. For example, the fund provider device 106 and/or the fund receiver device 107 may blink a light thereof, generate a sound therefrom, cause movement thereof (e.g., vibrate), and/or the like to indicate the transfer has been completed. The transfer indication may comprise a transfer notification message received by the fund provider device 106 and/or the fund receiver device 107.

Referring again to FIG. 1 and referring to FIGS. 6A-6D, systems and method for conducting a person-to-person fund transfer between a fund provider and a fund receiver are shown according to some non-limiting embodiments or aspects.

Referring to FIG. 6A, in some non-limiting embodiments or aspects, the Processor may generate a computer-readable code 604 usable by the fund provider device 106 to generate the fund transfer request. The computer-readable code 604 may comprise data associated with at least one of the following: at least one fund provider, at least one fund receiver, at least one fund benefactor, a fund amount, or any combination thereof. The computer-readable code 604 may comprise a barcode, such as a one-dimensional linear barcode, a two-dimensional matrix barcode (e.g., QR code and the like), or any other type of computer-readable code 604 storing data.

In some non-limiting embodiments or aspects, the Processor may generate the computer-readable code 604 and associate the computer-readable code 604 with at least one fund receiver, such that each potential fund receiver (e.g., of a particular merchant in the tipping/gratuity embodiments) has an associated computer-readable code 604.

In some non-limiting embodiments or aspects, the Processor may generate the computer-readable code 604 and associate the computer-readable code 604 with at least one service category associated with a plurality of potential fund receivers, such that each service category has an associated computer-readable code 604. The fund transfer based on the computer-readable code may be transferred to a fund associated with the associated service category, such that the fund receivers associated therewith may split funds transferred to the service category's account (e.g., a tip fund account of a restaurant split among the wait staff of the restaurant). The fund provider device 106 may read the computer-readable code 604 associated with the service category, which may provide the fund provider device 106 with potential fund receivers associated with the service category. The fund provider device may determine (e.g., select) the fund receiver(s) from the service category and assign at least a portion of the fund amount for transfer to the determined fund receiver(s).

The Processor may generate the computer-readable code 604 and associate the computer-readable code 604 with a predetermined fund amount, such that each potential fund amount has an associated computer-readable code 604.

Referring to FIGS. 6A-6B, the fund provider device 106 may receive the computer-readable code 604 useable to generate the fund transfer request. As shown in FIG. 6A, the computer-readable code 604 may be printed on a physical medium 602 (e.g., by the Processor). The physical medium 602 may comprise a paper medium. The physical medium 602 may comprise a uniform of the fund receiver. The physical medium 602 may comprise a medium proximate the fund receiver or a workspace of the fund receiver. The physical medium 602 may comprise any other medium accessible to the fund receiver. The fund provider device 106 may scan the physical medium 602 containing the computer-readable code 604 to read the computer-readable code 604.

With continued reference to FIGS. 6A-6B, in some non-limiting embodiments or aspects, the fund provider device 106 may receive the computer-readable code 604 by reading (e.g., scanning) the computer-readable code 604. By reading the computer-readable code 604, the fund provider device 106 may read the data associated with the fund receiver and, in response, determine the fund receiver. The fund provider device 106 may generate a fund transfer request comprising the fund receiver. Referring to FIG. 6C, the fund provider device 106 may select a fund amount, which fund amount may be included in the generated fund transfer request.

In some non-limiting embodiments or aspects, the fund provider device 106 may initiate the fund transfer process as previously described to transfer at least a portion of the fund amount to the fund receiver(s). The fund transfer process may be initiated by the fund provider device 106 communicating the fund transfer request generated based at least partially using the computer-readable code 604 to the Processor.

Referring to FIG. 6D, in some non-limiting embodiments or aspects, the fund receiver device 107 may receive a fund transfer notification generated by the processor, notifying the fund receiver device 107 that a fund amount has been transferred to the fund receiver. The fund transfer notification may identify the fund provider, the fund receiver, the fund amount, a customized message, and/or the like. The fund provider device 106 may receive a notification message that the fund transfer has been completed.

In some non-limiting embodiments or aspects, in response to the fund receiver receiving the portion of the fund amount, a second transfer may be automatically initiated of at least a portion of the fund amount to at least one fund benefactor. This may be automatically initiated without the fund receiver taking any active step at the time the portion of the fund amount is received from the fund provider.

Referring now to FIG. 7, FIG. 7 is a diagram of example components of a device 700. Device 700 may correspond to, for example one or more devices of the previously described devices, such as one or more devices of transaction service provider system 102, issuer system 104, fund provider device 106, fund receiver device 107, merchant system 108, fund benefactor device 109, and/or acquirer system 110. In some non-limiting embodiments or aspects, transaction service provider system 102, issuer system 104, fund provider device 106, fund receiver device 107, merchant system 108, fund benefactor device 109, and/or acquirer system 110 may include at least one device 700 and/or at least one component of device 700. As shown in FIG. 7, device 700 may include bus 702, processor 704, memory 706, storage component 708, input component 710, output component 712, and communication interface 714.

Bus 702 may include a component that permits communication among the components of device 700. In some non-limiting embodiments or aspects, processor 704 may be implemented in hardware, software, or a combination of hardware and software. For example, processor 704 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 706 may include random access memory (RAM), read-only memory (ROM), and/or another type of dynamic or static storage device (e.g., flash memory, magnetic memory, optical memory, and/or the like) that stores information and/or instructions for use by processor 704.

Storage component 708 may store information and/or software related to the operation and use of device 700. For example, storage component 708 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 710 may include a component that permits device 700 to receive information, such as via user input (e.g., a touch screen display, a keyboard, a keypad, a mouse, a button, a switch, a microphone, a camera, and/or the like). Additionally or alternatively, input component 710 may include a sensor for sensing information (e.g., a global positioning system (GPS) component, an accelerometer, a gyroscope, an actuator, and/or the like). Output component 712 may include a component that provides output information from device 700 (e.g., a display, a speaker, one or more light-emitting diodes (LEDs), and/or the like).

Communication interface 714 may include a transceiver-like component (e.g., a transceiver, a receiver and transmitter that are separate, and/or the like) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 7 are provided as an example. In some non-limiting embodiments or aspects, device 700 may include additional components, fewer components, different components, or differently arranged components than those shown in FIG. 7. Additionally or alternatively, a set of components (e.g., one or more components) of device 700 may perform one or more functions described as being performed by another set of components of device 700.

Referring to FIG. 8, a computer-implemented method 800 is shown for fund disbursement and notification according to some non-limiting embodiments or aspects. At a step 802, at least one processor described herein may receive a fund transfer request comprising at least one of the following: at least one fund provider, at least one fund receiver, a fund amount, or any combination thereof. At a step 804, in response to determining at least one fund benefactor associated with the at least one fund receiver, at least one processor described herein may transfer to or initiate the transfer of at least a portion of the fund amount to the at least one fund benefactor. At a step 806, at least one processor described herein may generate and transmit a transfer notification to at least one of the following: the at least one fund provider, the at least one fund receiver, the at least one fund benefactor, or any combination thereof.

Referring to FIG. 9, a computer-implemented method 900 is shown for conducting a person-to-person fund transfer between a fund provider and a fund receiver. At a step 902, at least one processor described herein may receive a computer-readable code comprising data associated with at least one of the following: at least one fund provider, at least one fund receiver, a fund amount, or any combination thereof. At a step 904, at least one processor described herein may read the computer-readable code. At a step 906, at least one processor described herein may, in response to reading the computer-readable code, determine the at least one fund receiver and the fund amount. At a step 908, at least one processor described herein may initiate the transfer of at least a portion of the fund amount to the at least one fund receiver.

In a further, non-limiting embodiment or aspect, a computer program product for fund disbursement and notification and/or conducting a person-to-person fund transfer between a fund provider and a fund receiver includes at least one non-transitory computer-readable medium including program instructions that, when executed by at least one processor, cause the at least one processor to execute one of the previously-described methods. The at least one processor may include the transaction service provider system 102, issuer system 104, fund provider device 106, fund receiver device 107, merchant system 108, fund benefactor device 109, and/or acquirer system 110.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A computer-implemented method for fund disbursement and notification, comprising:
receiving, with at least one processor, a fund transfer request comprising at least one of the following: at least one fund provider, at least one fund receiver, a fund amount, or any combination thereof;
in response to determining at least one fund benefactor associated with the at least one fund receiver, transferring to or initiating the transfer of, with at least one processor, at least a portion of the fund amount to the at least one fund benefactor; and
generating and transmitting, with at least one processor, a transfer notification to at least one of the following: the at least one fund provider, the at least one fund receiver, the at least one fund benefactor, or any combination thereof.

2. The computer-implemented method of claim 1, wherein the fund transfer request further comprises at least one service category associated with a plurality of fund receivers.

3. The computer-implemented method of claim 2, comprising:
determining, with at least one processor, at least one fund receiver of the plurality of fund receivers in the at least one service category; and
assigning, with at least one processor, at least a portion of the fund amount for transfer to the at least one fund receiver.

4. The computer-implemented method of claim 1, wherein a plurality of fund benefactors are associated with the at least one fund receiver.

5. The computer-implemented method of claim 4, comprising:
determining, with at least one processor, at least one fund benefactor of the plurality of fund benefactors; and
assigning, with at least one processor, at least a portion of the fund amount for transfer to the at least one fund benefactor.

6. A system for conducting a person-to-person fund transfer between a fund provider and a fund receiver, comprising:
a fund provider device having at least one processor, the fund provider device programmed or configured to:
determine or select a fund receiver and a fund amount;
generate a fund transfer request comprising the fund receiver and the fund amount; and
transmit the fund transfer request; and
a fund receiver device having at least one processor, the fund receiver device programmed or configured to:
communicate fund receiver data to the fund provider device,
wherein a fund transfer process is initiated from the fund provider to the fund receiver based on the fund transfer request.

7. The system of claim 6, wherein at least one of the fund provider device and the fund receiver device comprises at least one of the following: a computing device, a mobile device, an electronic device, a wearable device, a wireless communication device, or any combination thereof.

8. The system of claim 6, wherein the fund transfer process is initiated in response to arranging the fund provider device proximate the fund receiver device.

9. The system of claim 8, wherein the fund receiver device comprises a wearable device worn by the fund receiver.

10. The system of claim 6, wherein a transfer indication is displayed on at least one of the fund provider device and the fund receiver device upon completion of the fund transfer process.

11. The system of claim 6, wherein the fund transfer process further comprises automatically initiating a transfer of at least a portion of the fund amount to at least one fund benefactor.

12. The system of claim 6, wherein the initiation of the fund transfer automatically occurs upon receipt of the fund transfer request on the fund receiver device.

13. A computer-implemented method for conducting a person-to-person fund transfer between a fund provider and a fund receiver, comprising:
receiving, with at least one processor, a computer-readable code comprising data associated with at least one of the following: at least one fund provider, at least one fund receiver, a fund amount, or any combination thereof;
reading, with at least one processor, the computer-readable code;
in response to reading the computer-readable code, determining, with at least one processor, the at least one fund receiver and the fund amount; and
initiating, with at least one processor, the transfer of at least a portion of the fund amount to the at least one fund receiver.

14. The computer-implemented method of claim 13, further comprising:
generating, with at least one processor, the computer-readable code; and
associating, with at least one processor, the computer-readable code with at least one fund receiver.

15. The computer-implemented method of claim 13, wherein the computer-readable code comprises a QR code.

16. The computer-implemented method of claim 13, further comprising:
printing, with at least one printing device, the computer-readable code on a physical medium.

17. The computer-implemented method of claim 13, wherein the computer-readable code comprises at least one service category associated with a plurality of fund receivers.

18. The computer-implemented method of claim 17, comprising:
determining, with at least one processor, at least one fund receiver of the plurality of fund receivers in the at least one service category; and
assigning, with at least one processor, at least a portion of the fund amount for transfer to the at least one fund receiver.

19. The computer-implemented method of claim 13, further comprising generating, with at least one processor, a fund transfer notification comprising at least one of the following: the at least one fund provider, the at least one fund receiver, the fund amount, a message, or any combination thereof.

20. The computer-implemented method of claim 13, wherein in response to the at least one fund receiver receiving the at least a portion of the fund amount, a second transfer of at least a portion of the fund amount to at least one fund benefactor is automatically initiated.
